(19) United States
(12) Patent Application Publication
(10) Pub. No.: US 2023/0367453 A1
(43) Pub. Date: Nov. 16, 2023

(54) INFORMATION PROCESSING DEVICE AND MENU DISPLAY METHOD

(71) Applicant: Faurecia Clarion Electronics Co., Ltd., Saitama (JP)

(72) Inventors: Kazuya NINOMIYA, Saitama (JP); Taishin KONISHI, Saitama (JP); Haruki ONO, Saitama (JP); Shingo TAKEI, Saitama (JP); Kazunori SATO, Saitama (JP); Toshiyuki TAKATANI, Saitama (JP)

(21) Appl. No.: 18/195,093

(22) Filed: May 9, 2023

(30) Foreign Application Priority Data
May 10, 2022 (JP) 2022-077748

(51) Int. Cl. G06F 3/0482

(52) U.S. Cl. CPC G06F 3/0482

(57) ABSTRACT

To improve user convenience when selecting items, an information processing device includes: a display control unit for controlling display of a menu screen containing at least one of a plurality of items for respectively instructing execution of a plurality of functions; an evaluation unit for evaluating use frequency of each of the plurality of functions within a first period; an alteration proposal unit that provides a proposal to an user regarding changing the appearance of some of the items on the menu screen based on the use frequency; and an alteration execution unit for executing the change in the case an instruction to accept the proposal is received from the user.

### FIELD OF INVENTION

The present invention relates to an information processing device and a menu display method.

### BACKGROUND

In information processing devices such as infotainment devices for automobiles, smartphones, and tablet terminals, a plurality of items may be displayed on a display unit such as a liquid-crystal display to prompt a user to select an item. For example, in an infotainment device, items corresponding to respective sound sources of FM (Frequency Modulation) radio, AM (Amplitude Modulation) radio, and television are displayed on a display unit to prompt a user to select a sound source. The user can watch or listen to their favorite music or program by selecting their desired sound source.

However, displaying a large number of items on the display unit is troublesome to a user who uses only a small number of the functions. In order to avoid this, a method of automatically rearranging and displaying a plurality of items in descending order of the number of times of use has been proposed in JP2006244155 A.

### SUMMARY

However, simply rearranging the items automatically does not always display the items on the display unit that the user really wants to use.

In light of this manner of circumstances, an object of the present invention is to improve convenience to the user when items are selected.

The present application includes a plurality of means for solving at least a part of the problems described above, and examples thereof are as follows.

In order to resolve the problems described above, an aspect of the present invention is an information processing device, including:
a display control unit for controlling display of a menu screen containing at least one of a plurality of items for respectively instructing execution of a plurality of functions;
an evaluation unit for evaluating use frequency of each of the plurality of functions within a first period by a user;
an alteration proposal unit that provides a proposal to an user regarding changing the appearance of some of the items on the menu screen based on the use frequency; and
an alteration execution unit for executing the change in a case an instruction to accept the proposal is received from the user.

According to an aspect of the present invention, convenience for a user when selecting an item can be improved.

Problems, configurations, and effects other than those described above will become apparent from the following description of embodiments.

### BRIEF DESCRIPTION OF THE DRAWINGS

FIG. 1 is a diagram illustrating an example of a hardware configuration of an information processing device according to an embodiment of the invention.

FIG. 2 is a schematic diagram illustrating an example of a functional configuration of the information processing device according to the embodiment.

FIG. 3A is a schematic diagram illustrating an example of a menu screen, and FIG. 3B is a schematic diagram illustrating an example of a sub-menu screen.

FIG. 4A is a schematic diagram illustrating an example of browse time information, and

FIG. 48 is a schematic diagram illustrating an example of operation count information.

FIG. 5 is a schematic diagram illustrating an example of display item information.

FIG. 6 is a diagram illustrating an example of a flowchart of the menu display method according to the embodiment.

FIG. 7 is a schematic diagram illustrating an example of a menu screen before the appearance is changed.

FIG. 8 is a diagram illustrating an example of a flowchart of the appearance change process.

FIG. 9 is a schematic diagram illustrating an example of the deletion proposal screen.

FIG. 10 is a schematic diagram illustrating an example of a move completion screen.

FIG. 11 is a schematic diagram illustrating an example of an addition proposal screen.

FIG. 12 is a schematic diagram illustrating an example of the addition completion screen.

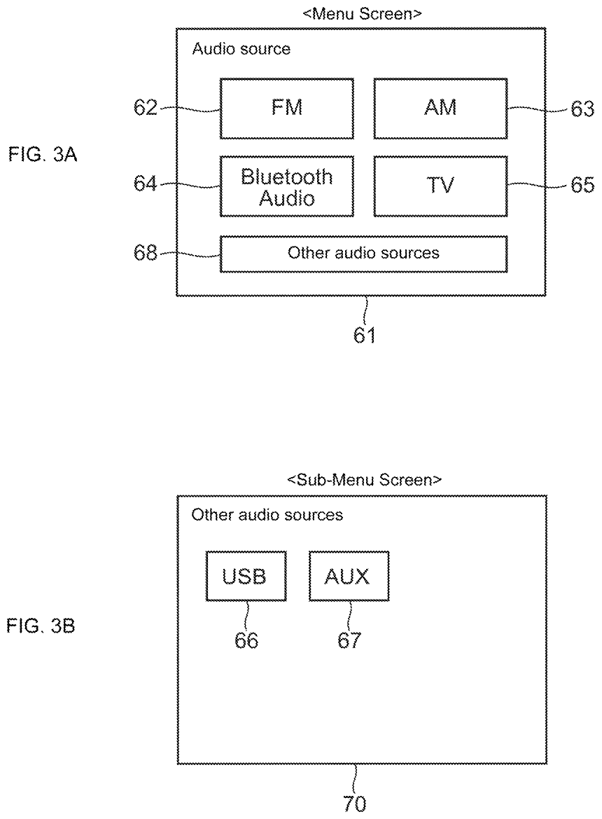

FIG. 13A is a schematic diagram illustrating an example of a menu screen when a USB button is added to the state of FIG. 3A, and FIG. 13B is a schematic diagram illustrating an example of a sub-menu screen for this case,

### DETAILED DESCRIPTION OF EMBODIMENTS

Hereinafter, an embodiment of the present invention will be described with reference to the drawings. In all the drawings, the same members are denoted by the same reference numerals in principle, and repeated description thereof will be omitted as appropriate. In addition, in the following embodiments, the structural elements (including element steps and the like) are not necessarily indispensable unless otherwise specified or except the case where they are considered to be apparently indispensable in principle. In addition, when phrases such as “composed of A,” “contains A,” “comprises A,” “has A,” or “includes A” are used, other elements are not excluded unless otherwise specified. In the following embodiments, when a shape, a positional relationship, or the like of a structural element or the like is referred to, those substantially similar in shape or the like are included unless otherwise excluded or considered to be clearly excluded in principle.

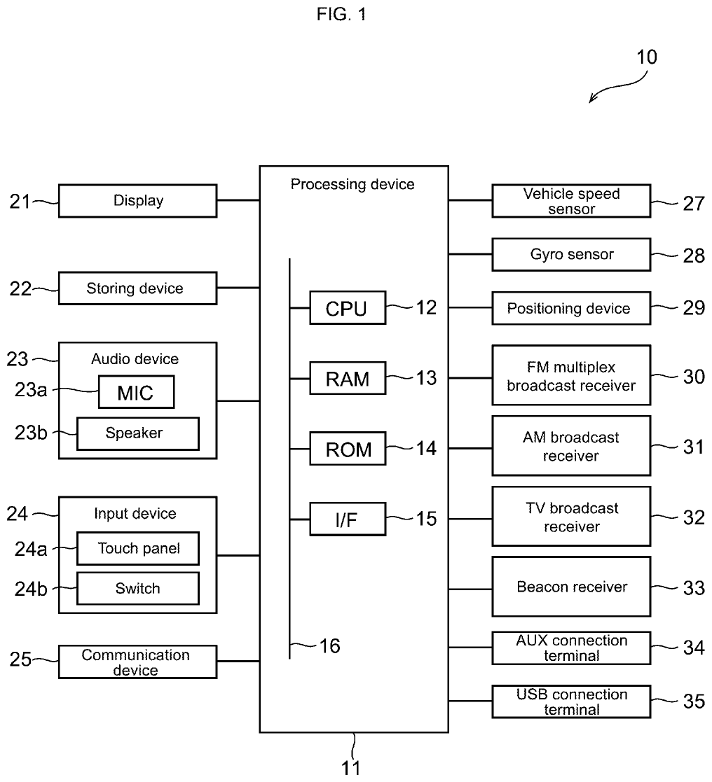

FIG. 1 illustrates an example of a hardware configuration of an information processing device according to the embodiment.

An information processing device 10 is, for example, an in-vehicle infotainment device having a navigation function, broadcast reception function, and audio playback function. As an example, the information processing device 10 is a box-shaped device including a display 21 on a front surface thereof, and is stowed on a console panel in a vehicle. In addition, the information processing device 10 may include a mounting fixture (bracket) for mounting on the console panel, and may be mounted on the console panel in the vehicle or the like via the mounting fixture. The navigation function of the information processing device 10 includes display of map information, route search from a departure point to a destination, guidance along a route, and display of traffic information.

Note that the information processing device 10 is not limited to an in-vehicle infotainment device and may be another in-vehicle device or a computer device such as a smartphone, a tablet computer, or a personal computer.

The information processing device 10 also displays a menu screen for selecting audio, radio, and television sound sources in addition to the navigation screen related to the navigation function. Furthermore, the information processing device 10 also displays an air conditioner screen for setting the temperature or air flow rate of the air conditioner. The information processing device 10 may display a screen of a web browser, a mailer, or a social network service (SNS). As another example, the information processing device 10 may display a telephone screen for making and receiving calls or a camera screen for displaying an image captured by an on-vehicle camera.

In the embodiment, the information processing device 10 includes a processing device 11, a display 21, a storing device 22, an audio device 23, an input device 24, and a communication device 25. Furthermore, the information processing device 10 includes a vehicle speed sensor 27, a gyro sensor 28, a positioning device 29, an FM multiplex broadcast receiver 30, an AM broadcast receiver 31, a TV broadcast receiver 32, a beacon receiver 33, an AUX (Auxiliary) connection terminal 34, and a USB (Universal Serial Bus) connection terminal 35.

The processing device 11 is a unit that controls each part of the information processing device 10. The processing device 11 detects the current location using, for example, information output from the positioning device 29 as well as from various sensors including the vehicle speed sensor 27. The processing device 11 reads map information necessary for display from the storing device 22 based on the detected current location. The processing device 11 graphically expands the read map information, and generates and outputs a video signal for displaying a mark indicating the current position on the map information on the display 21. The processing device 11 calculates a recommended route from the current location to the destination set by the user using the map information and the like stored in the storing device 22. The processing device 11 outputs a prescribed video signal to the display 21 to control screen display for route guidance. The processing device 11 outputs a prescribed audio signal to a speaker 23b to control the audio output for route guidance.

As an example, the processing device 11 includes a central processing unit (CPU) 12, random access memory (RAM) 13, read only memory (ROM) 14, and an interface (I/F) 15. These devices are connected to each other by a bus 16.

The CPU 12 is a processor having a function of controlling each device and a numerical calculation function. The ROM 13 is hardware that stores map information or computation information. The RAM 14 is a device that temporarily stores map information or calculation information recorded in the ROM 13 or the storing device 22. The I/F 15 is an interface for connecting various types of hardware to the processing device 11.

The display 21 is installed at the center of a console panel provided on a front surface inside the vehicle. As an example, the display 21 is a liquid crystal display or an organic electro luminescence (EL) display. A transparent touch panel 24a is overlain on the display 21 and enables the user to input an input operation to the information processing device 10 by performing touch operation on the display 21. The user may perform an input operation using a switch 24b as well.

The storing device 22 is a readable and writable storage medium (i.e., a non-transitory computer-readable medium) such as a hard disk drive (HDD), a solid state drive (SSD), or a nonvolatile memory card. The storing device 22 stores, for example, map information and the like used by the processing device 11.

The audio device 23 includes a microphone (MIC) 23a and the speaker 23b. The MIC 23a captures voices uttered by the driver and passengers. The speaker 23b outputs, for example, audio generated by the processing device 11 to the driver for route guidance.

The input device 24 is hardware for a user to perform an input operation. The input device 24 includes a touch panel 24a and a switch 24b overlain on the display 21. The input device 24 outputs information corresponding to input operation of a user to the processing device 11 or other hardware.

The communication device 25 is an interface for wirelessly connecting an external device and the information processing device 10. As an example, the communication device 25 wirelessly connects an external device and the information processing device 10 according to a standard based on Bluetooth (registered trademark). As another example, the communication device 25 connects to a prescribed server via a network such as a mobile phone communication network or the Internet, and receives information such as map information or an application program.

The vehicle speed sensor 27 acquires a value used to calculate the vehicle speed of the host vehicle. The gyro sensor 28 is constituted by, for example, an optical fiber gyro or a vibration gyro, and detects the angular velocity of the vehicle. The positioning device 29 receives a positioning signal transmitted from a positioning satellite such as a global positioning system (GPS) satellite, and measures the current position of the host vehicle evaluated by latitude, longitude, and altitude based on the received positioning signal

The FM multiplex broadcasting receiver 30 is hardware for receiving FM broadcasting including FM multiplex broadcasting. For example, VICS (Vehicle Information and Communication System) information is superimposed on the FM multiplex broadcast. The VICS information provides, for example, general current traffic information, regulatory information, SA/PA (service area/parking area) information, parking lot information, weather information, and text information.

The AM broadcast receiver 31 is hardware for receiving AM broadcasting. The TV broadcast receiver 32 is hardware for receiving TV broadcasting such as a terrestrial digital television broadcast.

The beacon receiver 33 receives, for example, general current traffic information, regulation information, SA/PA information, parking lot information, weather information, and VICS information including emergency alerts. Examples of the beacon receiver 33 include: an optical beacon that communicates using light, a radio beacon that communicates by radio waves, and the like.

The AUX connection terminal 34 is a terminal for inputting an audio signal output from an external audio device to the information processing device 10. The USB connection terminal 35 is a terminal for performing data communication with an external USB device, and also enables input of audio data output by the USB device to the information processing device 10.

Next, a functional configuration of the information processing device 10 will be described.

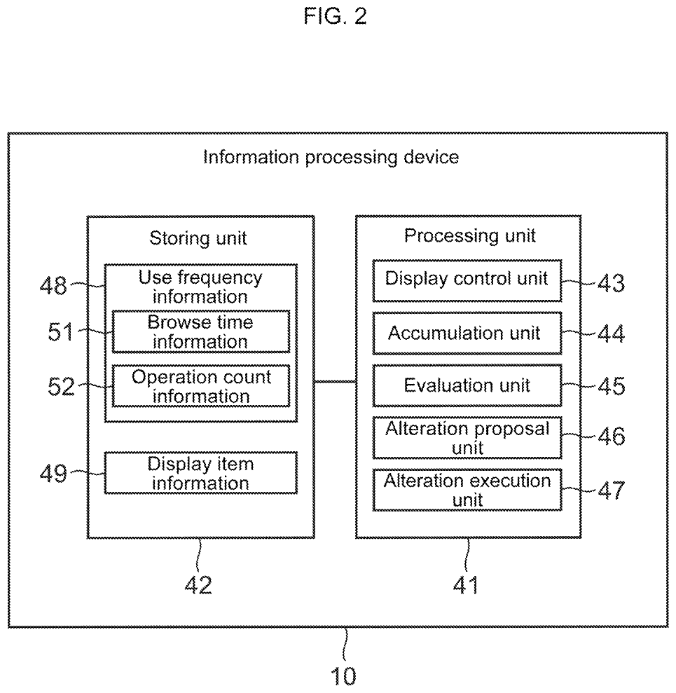

FIG. 2 is a schematic diagram illustrating an example of a functional configuration of the information processing device 10 according to the embodiment.

As illustrated in FIG. 2, the information processing device 10 includes a processing unit 41 and a storing unit 42. The processing unit 41 is achieved by means of the CPU 12 of the processing device 11 loading and executing a program from the ROM 14 into RAM 13. As an example, the processing unit 41 includes a display control unit 43, an accumulation unit 44, an evaluation unit 45, an alteration proposal unit 46, and an alteration execution unit 47.

The display control unit 43 is a processing unit that performs control to display a menu screen on the display 21.

FIG. 3A is a schematic diagram illustrating an example of a menu screen 61. The menu screen 61 includes an FM button 62, an AM button 63, a Bluetooth audio button 64, and a TV button 65 for specifying execution of each function included in the information processing device 10. These buttons 62 to 65 are examples of items displayed on the menu screen 61, and are buttons for the user to select audio, radio, and television sound sources.

The FM button 62 is a button for instructing the processing device 11 to execute the function of outputting sound from FM broadcasts received by the FM multiplex broadcast receiver 30 to the speaker 23b. The AM button 63 is a button for instructing the processing device 11 to execute a function of outputting sound from AM broadcasts received by the AM broadcast receiver 31 to the speaker 23b.

The Bluetooth audio button 64 is a button for instructing the processing device 11 to execute a function of connecting the communication device 25 and an external device in compliance with Bluetooth standard and outputting an audio signal output by the device to the speaker 23b.

The TV button 65 is a button for instructing the processing device 11 to execute a function of outputting audio of a TV broadcast received by the TV broadcast receiver 32 to the speaker 23b and displaying video of the TV broadcast on the display 21.

The menu screen 61 also includes an other audio source button 68. The other audio source button 68 is a button for displaying a sub-menu screen,

FIG. 3B is a schematic diagram showing an example of the sub-menu screen 70. The sub-menu screen 70 is a screen for displaying items that are not displayed on the menu screen 61. In the example of FIG. 3B, a USB button 66 and an AUX button 67 are displayed on the sub-menu screen 70. In this manner, item 3 is an example of a button that is not displayed on the menu screen 61 but is displayed on the sub-menu 70.

The USB button 66 is a button for instructing the processing device 11 to execute a function of acquiring audio data output from an external USB device through the USB connection terminal 35 and outputting the audio signal obtained from the audio data to the speaker 23b.

The AUX button 67 is a button for instructing the processing device 11 to execute a function of acquiring an audio signal output from an external audio device via the AUX connection terminal 34 and outputting the audio signal to the speaker 23b.

For example, when there is a user operation for displaying the menu screen 61 from the main menu screen (not shown) or the like after starting the engine, the display control unit 43 controls display of the menu screen 61 on the display 21.

Only one of the menu screen 61 and the sub-menu screen 70 is displayed on the display 21, and the display control unit 43 does not perform control to display these simultaneously.

As will be described below, only frequently used buttons are displayed on the menu screen 61, and less frequently used buttons are displayed on the sub-menu screen 70. Thus, the number of buttons displayed on the menu screen 61 can be reduced, and the user can easily search for their desired button. Furthermore, by normally displaying the menu screen 61 and displaying buttons, that the user is highly likely to use, on the menu screen 61, user convenience can be enhanced.

See FIG. 2 again. The accumulation unit 44 is a processing unit that aggregates the use frequency of each function in a predetermined aggregation period and stores the aggregation result in the storing unit 42 as use frequency information 48. The use frequency information 48 includes browse time information 51 and operation count information 52.

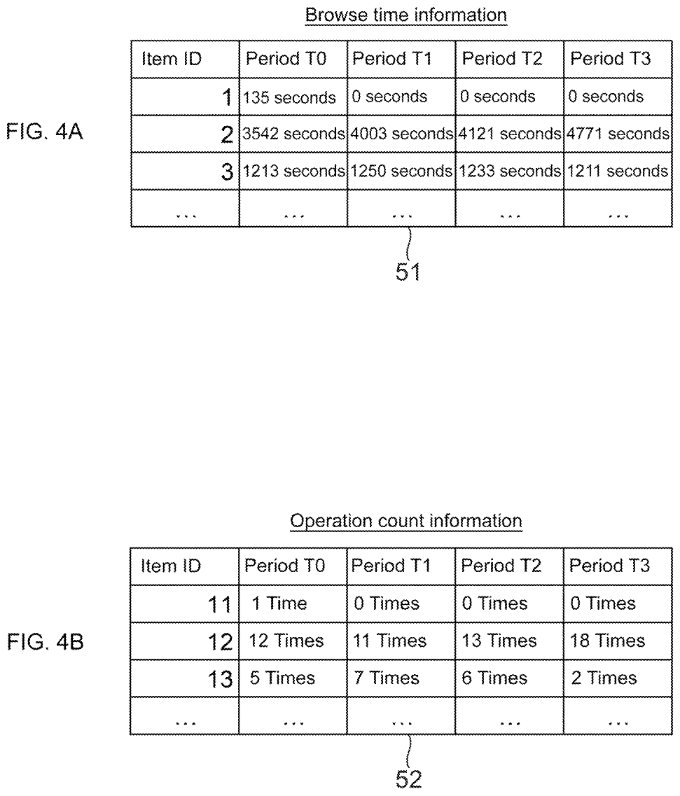

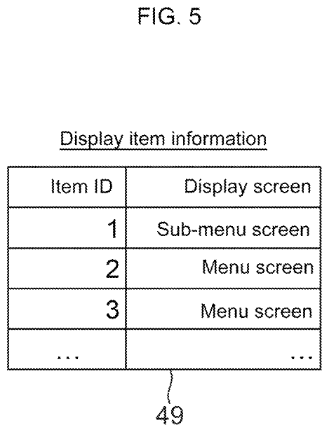

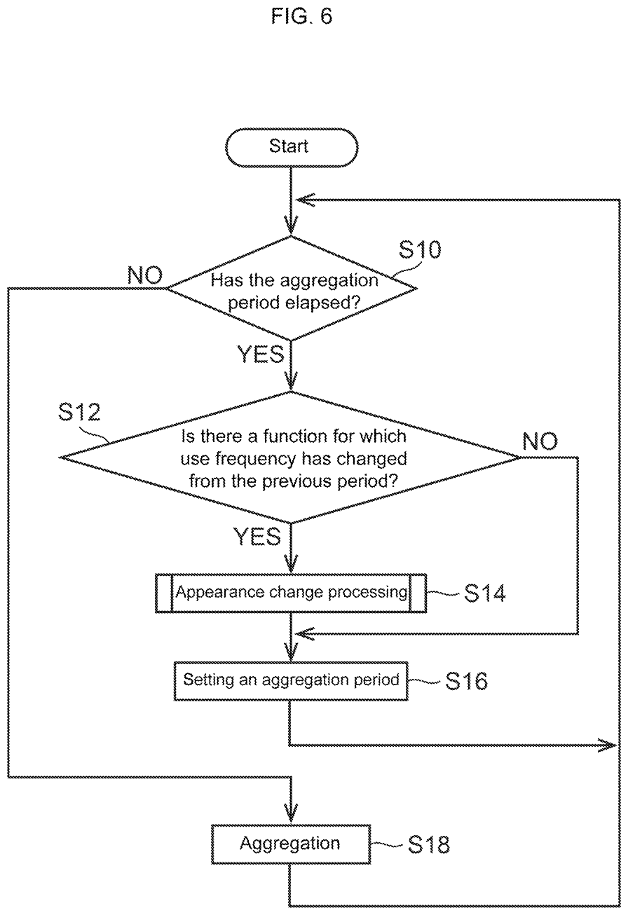

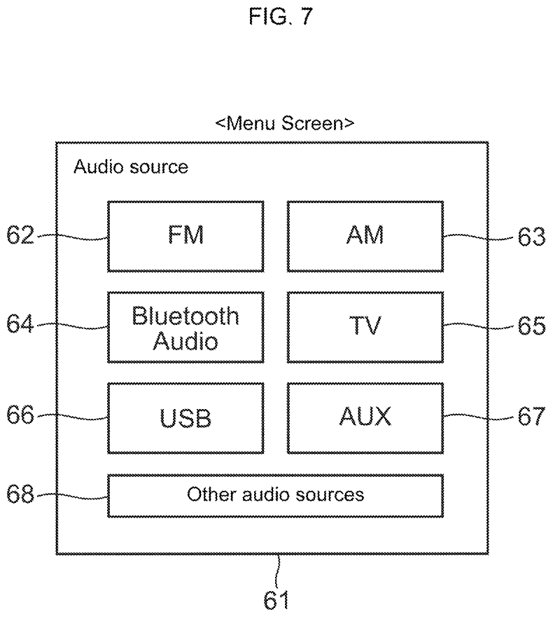

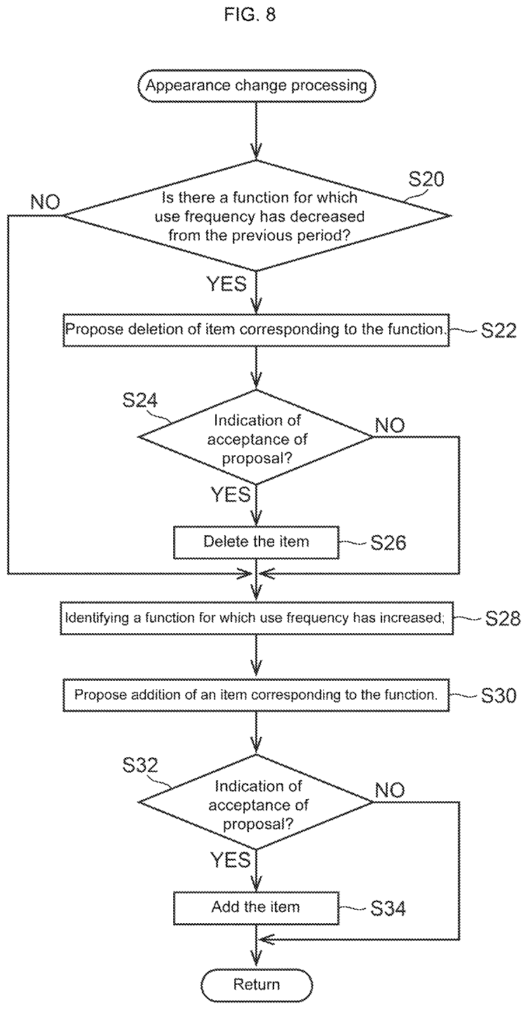

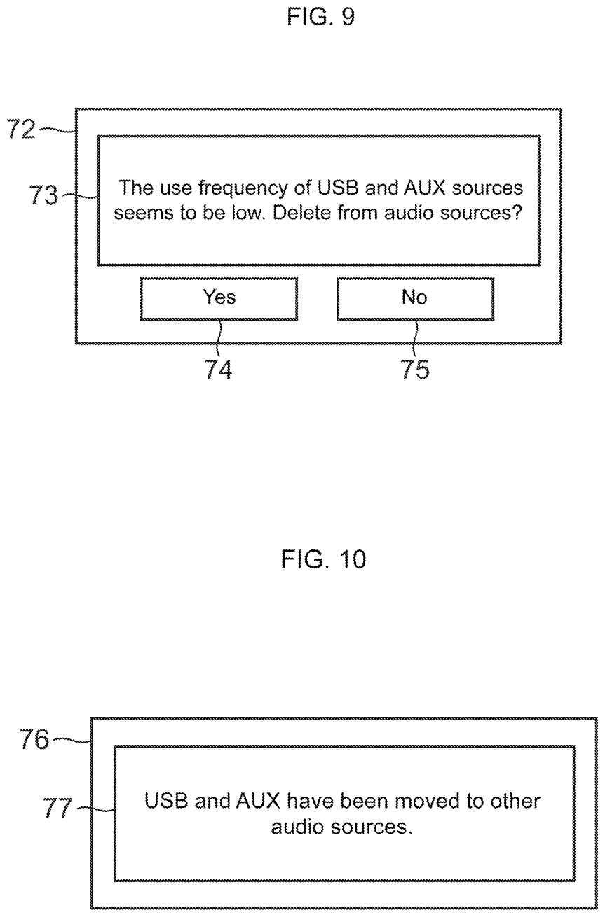

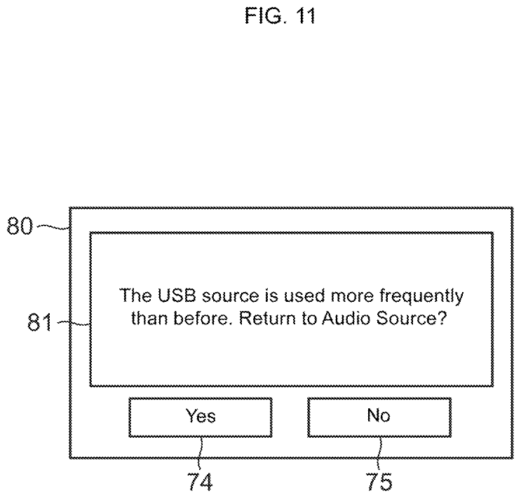

FIG. 4A is a schematic diagram illustrating an example of the browse time information 51.

The browse time information 51 is information in which an item ID is associated with a browse time of audio in each of the aggregation periods T0 to T3. An item ID is an identifier for uniquely identifying each of the buttons 62 to 67 related to audio, radio, and television.

Each of the aggregation periods T0 to T3 is a period in which the use frequency of the function is aggregated, and an integer value attached to each period indicates the order relationship of each period. In this example, “0” is the oldest aggregation period, and “1,” “2,” and “3” are newer aggregation periods in this order. If the length of each of the aggregation periods T0 to T3 is different for each period, the use frequency of the functions for each period cannot be compared later. Therefore, in the embodiment, the lengths of the aggregation periods T0 to T3 are set to be the same. As an example, the length of each of the aggregation periods T0 to T3 is roughly 3 days to 4 days.

In the example of FIG. 4A, if the item ID of the USE button 66 is “1,” the amount of time where the user listened to the sound obtained from audio data output by the external USB-device is 135 seconds in the aggregation period T0, and 0 seconds in the aggregation period T1 to T3. The aggregation period in the embodiment is a period obtained by accumulating periods during which the power supply of the information processing device 10 is turned on due to, for example, engine start. As a result, inequality in total browse time between a user who drives a car only a few days a week and a user who drives a car every day can be prevented.

FIG. 4B is a schematic diagram illustrating an example of the operation count information 52.

The operation count information 52 is information in which the item ID is associated with the number of operations in each of the aggregation periods T0 to T3.

The item ID in the operation count information 52 is an identifier for uniquely identifying a button displayed on the display 21 for instructing the processing device 11 to execute various functions as the navigation device. The buttons include a destination search button for searching for a destination and a search button for executing a route search.

As an example, the item ID of the destination search button is set to “11.” In this case, the number of times that the user presses the destination search button is one in the aggregation period T0, and is 0 in the aggregation periods T1 to T3.

The button identified by the item ID in the operation count information 52 is not limited to a button related to the navigation device as long as the number of operations can be counted for the button. This manner of buttons include, for example, buttons for setting the temperature or air flow rate of the air conditioner. In addition, a button for performing any operation of the web browser, the mailer, and SNS may be identified by the item ID. Furthermore, a button for placing and receiving a call or a button for adjusting an image captured by an on-vehicle camera may be identified by the item ID.

See FIG. 2 again. The evaluation unit 45 is a processing unit that evaluates the use frequency of each function of the information processing device 10 in the most recent aggregation period among the aggregation periods based on the use frequency information 48. As an example, a case where the item ID of the USB button 66 is “1” as in FIG. 4A is considered. In this case, according to the browse time information 51 of FIG. 4A, the browse time of the item ID “1” is 0 seconds in the most recent aggregation period T3. Therefore, the evaluation unit 45 provides evaluation that the use frequency of the function of outputting the audio signal output from the external USB device to the speaker 23b is 0 seconds in the most recent aggregation period T3.

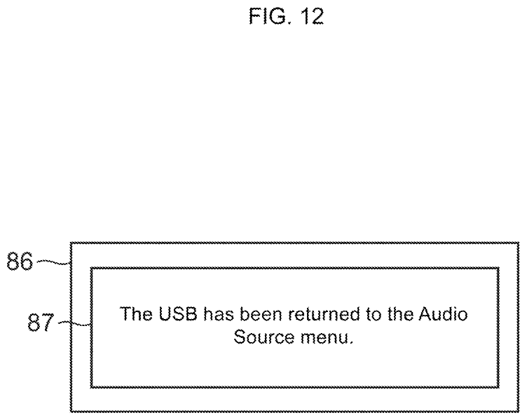

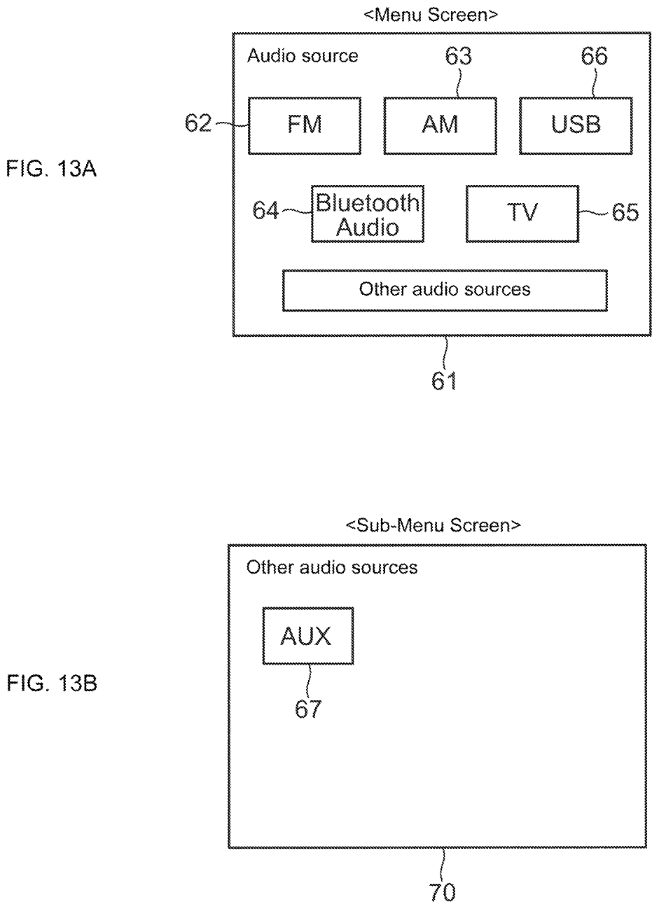

In addition, a case where the item ID of the destination search button is “11” as shown in FIG. 4B will be considered. In this case, according to the operation count information 52 of FIG. 48, the number of operations of the item ID “11” is 0 in the most recent aggregation period T3. Therefore, the evaluation unit 45 provides the evaluation that the use frequency of the destination search function is 0 times.

See FIG. 2 again. The alteration proposal unit 46 is a processing unit that suggests a change in the appearance of each of the buttons 62 to 65 on the menu screen 61 (see FIG. 3A) based on the use frequency evaluated by the evaluation unit 45.

For example, among the plurality of functions of the information processing device 10, when there is a function for which the use frequency in the most recent aggregation period T3 in FIGS. 4A and 4B is lower than the use frequency in the previous aggregation period T2, the use frequency of the function by the user is anticipated to have recently decreased. If a button corresponding to the function is displayed on the menu screen 61, an unnecessarily large number of buttons are displayed on the menu screen 61, and it is difficult for the user to find a button corresponding to a function that the user really wants to use. Therefore, in this case, the alteration proposal unit 46 proposes deleting from the menu screen 61 the button corresponding to the function for which use frequency has decreased. In this example, the aggregation period T3 is an example of a first period, and the aggregation period T2 is an example of a second period. The button for which deletion is proposed is an example of a first item.

On the other hand, when there is a function for which use frequency in the most recent aggregation period T3 is higher than the use frequency in the previous aggregation period T2, the use frequency of the function by the user is estimated to have recently increased. When the button corresponding to the function is not displayed on the menu screen 61 but displayed on the sub-menu screen 70, the user needs to press the other audio source button 68 on the menu screen 61 to display the sub-menu screen 70. This increases the time and effort required to reach the target button, which is troublesome for the user. Therefore, in this case, the alteration proposal unit 46 proposes adding a button to the menu screen 61 corresponding to the function for which use frequency has increased. This manner of button, for which addition is proposed, is an example of a second item.

The alteration execution unit 47 is a processing unit that executes the change when an instruction to accept the proposal is received from the user. As an example, the alteration execution unit 47 changes the appearance of the buttons on the menu screen 61 (see FIG. 3A) and the sub-menu screen 70 (see FIG. 3b) by changing the content of display item information 49 described below.

The storing unit 42 is implemented by means of the RAM 13, the ROM 14, and the storing device 22. As an example, the storing unit 42 stores the use frequency information 48 and the display item information 49 described above.

FIG. 5 is a schematic diagram illustrating an example of display item information 49.

The display item information 49 is information in which an item ID is associated with a display screen on which a button corresponding to the item ID is displayed. In the example of FIG. 5, the button corresponding to the item ID “1” is displayed on the sub-menu screen 70, and the button corresponding to the item ID “2” is displayed on the menu screen 61. The display control unit 43 displays a button corresponding to each item ID on one of the menu screen 61 and the sub-menu screen 70 according to the display item information 49.

Next, a menu display method according to the embodiment will be described.

FIG. 6 is a diagram illustrating an example of a flowchart of the menu display method according to the embodiment.

This flowchart is started at a timing when the power supply of the information processing device 10 is turned on such as, for example, by the engine being started,

First, the accumulation unit 44 determines whether the current aggregation period has elapsed (Step S10). For example, when there are a plurality of aggregation periods T0 to T3 as illustrated in FIGS. 4A and 4B, the accumulation unit 44 determines whether the current aggregation period T3 has elapsed.

If it is determined that the current aggregation period has elapsed (YES), processing proceeds to step S12. In step S12, the evaluation unit 45 determines whether or not there is a function of the plurality of functions of the information processing device 10 for which use frequency has changed as compared with the previous aggregation period.

For example, as shown in FIG. 4A, the current aggregation period is assumed to be T3, and the previous aggregation period is T2. In this case, the evaluation unit 45 refers to the browse time information 51 and determines whether there is an item ID for which the browse time in the current aggregation period T3 has changed from the browse time in the previous aggregation period T2. In the example of FIG. 4A, since the browse times of the item IDs “2” and “3” have changed from the previous time, the evaluation unit 45 determines that there is a function for which use frequency has changed as compared with the previous aggregation period.

Similarly, the evaluation unit 45 refers to the operation count information 52 in FIG, 4B and determines whether there is an item ID for which the number of operations in the current aggregation period T3 has changed from the number of operations in the previous aggregation period T2, In the example of FIG. 4B, since the number of operations of each of the item IDs “12” and “13” has changed from the previous time, the evaluation unit 45 determines that there is a function for which use frequency has changed as compared with the previous aggregation period.

As another example, the evaluation unit 45 may determine that there is a function for which use frequency has changed from the previous time when there is a function for which use frequency in the current aggregation period T3 has changed from the average value of use frequency in a plurality of aggregation periods T0 to T2 before the current aggregation period T3.

hi this manner, when it is determined that there is a function for which use frequency has changed compared with the previous aggregation period (step S12: YES), processing proceeds to step S14. In step S14, an appearance change process described below is performed.

Next, the accumulation unit 44 sets up the next aggregation period after the current aggregation period (step S16). As an example, the accumulation unit 44 sets a period having the same length as the current aggregation period as the next aggregation period. Specifically, the accumulation unit 44 adds the next aggregation period to the browse time information 51 (FIG. 4A) and the operation count information 52 (FIG. 4B).

Note that step S16 is executed even if it is determined in step S12 that there is no function for which use frequency has changed from the previous time. Thereafter, processing returns to step S10.

On the other hand, if it is determined in step S10 that the aggregation period has not elapsed, processing proceeds to step S18. In step S18, the accumulation unit 44 aggregates the use frequency of each function of the information processing device 10 during the current aggregation period. Thereafter, processing returns to step S10.

Thereafter, processing returns to step 310,

Next, the appearance change processing in step S14 will be described.

FIG. 7 is a schematic diagram illustrating an example of a menu screen 61 before the appearance is changed. As illustrated in FIG. 7, the FM button 62, the AM button 63, the Bluetooth audio button 64, the TV button, the USB button 66, and the AUX button 67 are assumed below to be displayed on the menu screen 61.

The appearance change process is a process of deleting, from the menu screen 61, a button related to a function with a low use frequency of the buttons 62 to 67, or newly adding a button with a high use frequency to the menu screen 61.

FIG. 8 is a diagram illustrating an example of a flowchart of the appearance change process.

First, the evaluation unit 45 determines whether or not there is a function for which use frequency is lower than that in the previous aggregation period of the functions of the information processing device 10 (step S20).

In the examples of FIGS. 4A and 4B, since the use frequencies of the item IDs “3” and “13” in the current aggregation period T3 are lower than the use frequencies in the previous aggregation period T2, the evaluation unit 45 determines that there is a function for which use frequency has been lowered. As another example, the evaluation unit 45 may determine whether the use frequency in the current aggregation period T3 is lower than the average value of the use frequencies in a plurality of aggregation periods T0 to T2 before the current aggregation period T3.

If it is determined that there is a function for which use frequency has decreased (step S20: YES), processing proceeds to step S22.

In step 322, the alteration proposal unit 46 provides a proposal to delete, from the menu screen 61, a button for instructing execution of a function for which use frequency is lower than that in the previous aggregation period. For example, on the menu screen 61 of FIG. 7, the use frequency of each of the USB button 66 and the AUX button 67 is assumed to have decreased from the previous aggregation period. In this case, the alteration proposal unit 46 displays, on the display 21, a deletion proposal screen for proposing deletion of these buttons from the menu screen 61.

FIG. 9 is a schematic diagram illustrating an example of the deletion proposal screen 72.

As illustrated in FIG. 9, the deletion proposal screen 72 includes a text display area 73 for displaying text proposing deletion, a “YES” button 74, and a “NO” button 75.

The “YES” button 74 is a button pressed by the user to accept the proposal. If the “YES” button is pressed, notification of an instruction to accept the proposal is provided from the alteration proposal unit 46 to the alteration execution unit 47.

The “NO” button 75 is a button pressed by the user to reject the proposal. If the “NO” button is pressed, notification of an instruction to reject the proposal is provided from the alteration proposal unit 46 to the alteration execution unit 47.

See FIG. 8 again. Next, the alteration execution unit 47 determines whether or not there is an instruction to accept the proposal (step S24). For example, the alteration execution unit 47 determines that there is an instruction to accept the proposal when the “YES” button 74 is pressed, and determines that there is no instruction to accept the proposal when the “NO” button 75 is pressed.

If there is an instruction to accept the proposal (step S24: YES), processing proceeds to step S26. In step S26, the alteration execution unit 47 updates the display screen associated with the item ID of the button for which deletion was proposed to the “sub-menu screen” in the display item information 49. Accordingly, the display control unit 43 moves the button for which deletion is proposed to the sub-menu screen 70 and deletes the button from the menu screen 61. In addition, the alteration execution unit 47 displays, on the display 21, a move completion screen indicating that moving of the button to the sub-menu screen 70 is complete.

FIG. 10 is a schematic diagram illustrating an example of a move completion screen.

As illustrated in FIG. 10, the move completion screen 76 includes a text display area 77 for displaying text indicating that moving is complete.

When moving of the USB button 66 and the AUX button 67 is completed as in this example, these buttons are deleted from the menu screen 61 as in 3A described above. Furthermore, as illustrated in FIG. 3B, the USB button 66 and the AUX button 67 are moved to the sub-menu screen 70.

As a result, the number of buttons displayed on the menu screen 61 is smaller than before moving (see FIG. 7), and the user can easily find a desired button on the menu screen 61, thereby improving convenience. In addition, the buttons displayed on the menu screen 61 are buttons related to functions for which use frequency has not decreased from the previous aggregation period, and are buttons that are anticipated to be used by the user in the future. Therefore, there is a high possibility that a button that the user wants to use is displayed on the menu screen 61, and convenience for the user is further improved.

See FIG. 8 again, Next, of the functions of the information processing device 10, the evaluation unit 45 evaluates functions for which use frequency has increased compared to the previous aggregation period (step S28).

In the examples of FIGS. 4A and 4B, since the use frequencies of the item IDs “2” and “12” in the current aggregation period T3 are higher than the use frequencies in the previous aggregation period T2, the evaluation unit 45 evaluates the functions corresponding to each of the item IDs “2” and “12.” As another example, the evaluation unit 45 may evaluate whether the use frequency in the current aggregation period T3 is higher than the average value of the use frequency in a plurality of aggregation periods T0 to T2 before the current aggregation period T3.

Step S28 is executed even if step S20 or step S24 are determined to be NO.

The alteration proposal unit 46 provides a proposal to add, to the menu screen 61, a button for instructing execution of a function for which use frequency is higher than that in the previous aggregation period (step 530). For example, in the states of FIGS. 3A and 3B, a case where the use frequency of the USB button 66 has increased from the previous aggregation period will be considered. In this case, the alteration proposal unit 46 displays, an addition proposal screen on the display 21 for proposing the addition of the USB button 66 to the menu screen 61.

FIG. 11 is a schematic diagram illustrating an example of an addition proposal screen 80.

As illustrated in FIG. 11, the addition proposal screen 80 includes a text display area 81 for displaying text proposing addition and the “YES” button 74 and “NO” button 75 described above,

See FIG. 8 again. Next, the alteration execution unit 47 determines whether or not there is an instruction to accept the proposal (step S32). For example, the alteration execution unit 47 determines that there is an instruction to accept the proposal when the “YES” button 74 is pressed, and determines that there is no instruction to accept the proposal when the “NO” button 75 is pressed.

If there is an instruction to accept the proposal (step S32: YES), processing proceeds to step S34. In step S34, the alteration execution unit 47 updates the display screen associated with the item ID of the button for which addition was proposed to the “menu screen” in the display item information 49. As a result, the display control unit 43 adds the button proposed to be added to the menu screen 61 and deletes the button from the sub-menu screen 70. In addition, the alteration execution unit 47 displays, on the display 21, an addition completion screen indicating that adding of the button to the menu screen 61 is complete.

FIG. 12 is a schematic diagram illustrating an example of the addition completion screen.

As illustrated in FIG. 12, the addition completion screen 86 includes a text display area 87 for displaying text indicating that the addition of the button to the menu screen 61 is complete.

FIG. 13A is a schematic diagram illustrating an example of the menu screen 61 for the case where the USB button 66 is added to the state of FIG. 3A. FIG. 13B is a schematic diagram illustrating an example of the sub-menu screen 70 in this case.

As illustrated in FIGS. 13A and 138, the USB button 66 is deleted from the sub-menu screen 70, and the USB button 66 is added to the menu screen 61.

Since the USB button 66 is a button related to a function for which use frequency has increased as compared with the previous aggregation period, the USB button 66 is anticipated to be used by the user in the future. Therefore, by displaying the USB button 66 on the menu screen 61, user convenience can be improved.

See FIG. 8 again. After step S34 is executed, the process returns to the call source.

Also, if NO is determined in step S32, processing returns to the call source.

Thus, the basic processing of the appearance change processing is completed.

According to the embodiment described above, the change of the appearance of the button on the menu screen 61 is proposed based on the use frequency of the function of the information processing device 10 (steps S22 and S30). When the user accepts this proposal, the appearance of the buttons on the menu screen 61 is changed (steps S26 and S28). Accordingly, the appearance of each button can be changed according to the use frequency of each function, and user convenience can be improved with regards to selecting each button. In addition, since the appearance of the menu screen 61 is changed when the user accepts the proposal, the user's intention is reflected in the appearance, and the menu screen 61 preferred by the user can be obtained.

### Modified Example

The present invention is not limited to that described above, and the following configuration may be adopted.

For example, a button for requesting that step S22 is not proposed for a certain period of time may be added to the deletion proposal screen 72 of FIG. 9. In this case, the alteration proposal unit 46 may perform not providing the proposal of step S22 for a specified period of time when the button is pressed and an instruction of not providing a proposal for a specified period of time is received. Similarly, the button may be added to the addition proposal screen 80 of FIG. 11, and when the button is pressed the alteration proposal unit 46 may perform not providing the proposal of step S30 for a specified period of time. As a result, annoyance felt by the user due to frequent reception of proposals can be reduced.

In addition, proposals may be suppressed for functions for which proposals of deletion have been received. As an example, when the user presses the “NO” button 75 in FIG. 9, the alteration proposal unit 46 may exclude the function from being subject for proposal to deletion in step 322 for a specified period of time even if this function is subject to being deleted. In addition, when the user presses the “YES” button 74 in FIG. 9, the alteration proposal unit 46 excludes this function from being subject to proposal for addition in step S30 for a specified period of time even if the function is subject to being added. In addition to the “YES” button 74 or the “NO” button 75, a check box for instructing whether or not to suppress the proposal may be displayed on the deletion proposal screen 72.

Conversely, the proposal may be suppressed for the function for which addition is proposed. As an example, when the user presses the “NO” button 75 in FIG. 11, the alteration proposal unit 46 may exclude the function from being subject for proposal to addition in step S30 for a specified period of time even if this function is subject to being added. When the user presses the “YES” button 74 in FIG. 11, the alteration proposal unit 46 excludes this function as subject to proposal for deletion in step S22 for a specified period of time even if the function is subject to being deleted. In addition to the “YES” button 74 or the “NO” button 75, a check box for instructing whether or not to suppress the proposal may be displayed on the additional proposal screen 80.

In addition, the appearance change process (step S14) of FIG. 6 does not need to be performed every time the aggregation period elapses, and the next appearance change process may not be performed until a prescribed time elapses after the appearance change process is performed.

As a result, since the alteration proposal unit 46 does not make a proposal until a prescribed time elapses after the previous proposal of step S22 or step 530, the stress felt by the user due to proposing the change of the appearance every time can be alleviated.

The effects described in the present specification are merely examples and are not limiting, and there may be other effects. In addition, the present invention is not limited to the embodiments described above, and includes various modifications. For example, each of the embodiments described above has been described in detail in order to describe one or more embodiments of the present invention in an easy-to-understand manner, and the present invention is not necessarily limited to a configuration including all of the structural elements described. In addition, a part of the configuration of a particular embodiment can be replaced with the configuration of another embodiment, and the configuration of a particular embodiment can be added to the configuration of another embodiment. In addition, a part of the configuration of each embodiment can be added to, deleted from, or replaced with another configuration.

In addition, some or all of the configurations, functions, processing units, processing means, and the like described above may be achieved by hardware, for example, by designing an integrated circuit. In addition, each of the configurations, functions, and the like described above may be achieved by software based on a processor interpreting and executing a program for implementing each function. Information such as a program for implementing each function, a determination table, and a file can be stored in a non-transitory, computer-readable medium (storing device) such as memory, an HDD, or an SSD, an integrated circuit (IC) card, a secure digital (SD) card, or a digital versatile disc (DVD). In addition, control lines and information lines that are considered to be necessary for description are illustrated, and all control lines and information lines in a product are not necessarily illustrated. It may be considered that almost all the components are, in practice, connected to each other.

### REFERENCE SIGNS LIST

10 Information processing device
41 Processing unit
42 Storing unit
43 Display control unit
44 Accumulation unit
45 Evaluation unit
46 Alteration proposal unit
47 Alteration execution unit
48 Use frequency information
49 Display item information
51 Browse time information
52 Operation count information.

1. An information processing device comprising:
a display control unit for controlling display of a menu screen including at least one of a plurality of items for respectively instructing execution of a plurality of functions;
an evaluation unit for evaluating use frequency of each of the plurality of functions within a first period;
an alteration proposal unit that provides a proposal to an user regarding changing the appearance of some of the items on the menu screen based on use frequency; and
an alteration execution unit for executing the change in a case an instruction to accept the proposal is received from the user.

2. The information processing device according to claim 1, wherein, when the use frequency of the function corresponding to a first item displayed on the menu screen among the plurality of items is lower than that in a second period that is prior to the first period, the alteration proposal unit provides a proposal to delete the first item from the menu screen.

3. The information processing device according to claim 1, wherein, when the use frequency of the function corresponding to a second item displayed on the menu screen among the plurality of items is higher than that in a second period that is prior to the first period, the alteration proposal unit provides a proposal to add the second item to the menu screen.

4. The information processing device according to claim 1, wherein the display control unit performs control to display, of the plurality of items, a third item that is not displayed on the menu screen, on a sub-menu screen that is different from the menu screen.

5. The information processing device according to claim 4, wherein the display control unit performs control to not display the sub-menu screen when the menu screen is displayed.

6. The information processing device according to claim 1, wherein in the case the instruction to not provide the proposal to change for a specified period of time is received from the user, the alteration proposal unit does not provide the proposal to change for the specified period of time.

7. The information processing device according to claim 1, wherein the alteration proposal unit does not provide the proposal again when a prescribed amount of time has not elapsed since the previous proposal was provided.

8. A method of displaying a menu screen executed by a computer, comprising the steps of:
performing control to display a menu screen including at least one of a plurality of items for respectively instructing execution of a plurality of functions;
evaluating use frequency by a user of each of the plurality of functions within a first time period;
providing a proposal to an user to change the appearance of some of the items on the menu screen based on the use frequency; and
executing the change when an instruction to accept the proposal is received from the user.

9. A method of displaying menu items on a menu screen of a display connected to an information processing device, wherein a user can launch a desired function of the information processing device by operating corresponding one of the menu items, comprising the steps of:
displaying the menu screen indicating a previously selected group of the menu items;
periodically accumulating frequency of using each function of the information processing device by the user;
providing the user with a proposal for replacement of the selected group to be displayed on the menu screen to the user by specifying a certain menu item to be replaced based on the accumulated frequency of using the function corresponding to the certain menu item; and
replacing the selected group of the menu items displayed on the menu screen according to the proposal if the user operates to accepts the proposal.

10. The method according to claim 9, wherein the replacement to delete the certain menu item from the menu screen is proposed when the frequency of using the function corresponding to the certain menu item has been lower than before.

11. The method according to claim 9, wherein the replacement to add the certain menu item to the menu screen is proposed when the frequency of using the function corresponding to the certain menu item has been higher than before.

12. The method according to claim 9, further comprising the step of displaying a sub menu screen indicating the menu items other than the selected group in place of the menu screen according to a request from the user.
